(19) United States
(12) Patent Application Publication
(10) Pub. No.: US 2008/0309916 A1
(43) Pub. Date: Dec. 18, 2008

(54) Auto Aim Reticle For Laser range Finder Scope

(75) Inventor: Kwok Hoo MOK, Hong Kong (HK)

Correspondence Address: WILLIAM J. SAPONE;COLEMAN SUDOL SAPONE P.C., 714 COLORADO AVENUE, BRIDGE PORT, CT, 06605, US

(73) Assignee: ALOT ENTERPRISES COMPANY LIMITED, Shaukeiwan (HK)

(21) Appl. No.: 11/764,514

(22) Filed: Jun. 18, 2007

(51) Int. Cl. G01C 3/00

(52) U.S. Cl. 356/5.01

(57) ABSTRACT

A laser range finder scope for measuring the distance between a target and the scope based on the time-of-flight of laser impulses is disclosed as including means for transmitting laser impulses toward the target and generating a first time signal corresponding to the transmission; means for receiving laser impulses reflected from the target and generating a second time signal corresponding to the reception; means for delaying said first time signal to provide a third time signal; means for calculating the time-of-flight by comparing said second time signal and third time signal; and a scope with a reticle with a plurality of indicia selectively lightable to each indicate the appropriate reticle scale to aim at the target.

This invention relates to a laser range finder scope, in particular such a range finder scope used for determining the distance of a target.

### BACKGROUND OF THE INVENTION

A known approach to measuring distance of a target is to measure the time of flight of a narrow beam of light emitted from the measuring system to and back from the target, and to calculate the distance of the target on the basis of the time that has elapsed. In a laser range finder, the pulse of light is a beam of laser.

Some such laser range finders are incorporated with a scope, or called telescopic sight, which is used for magnifying the image of the target for viewing and giving an accurate point of aim for weapons, such as firearms, airguns and crossbows. Such scopes come with a variety of different reticles, ranging from the traditional crosshairs to complex recticles designed to allow the shooter to estimate accurately the range to the target, to compensate for the bullet drop, and so on.

In such conventional laser range finder scopes, the measured distance is usually projected onto the scopes. This not only obstructs part of the image as viewed by the shooter, but the shooter also has to carry out calculation before adjusting the leveling of the weapon for accurate shooting. It is thus an object of the present invention to provide a laser range finder scope in which the aforesaid shortcomings are mitigated, or at least to provide a useful alternative to the public.

### SUMMARY OF THE INVENTION

According to a first aspect of the present invention, there is provided a laser range finder scope for measuring the distance between a target and the scope based on the time-of-flight of laser impulses; including means for transmitting laser impulses toward the target and generating a first time signal corresponding to the transmission; means for receiving laser impulses reflected from the target and generating a second time signal corresponding to the reception; means for delaying said first time signal to provide at least a third time signal; means for calculating the time-of-flight by comparing said second time signal and said third time signal; and a scope with a reticle with a plurality of indicia selectively lightable to each indicate the appropriate reticle scale to aim at the target.

According to a second aspect of the present invention, there is provided a method for indicating the distance of a target based on the time-of-flight of laser impulses; including steps of transmitting laser impulses toward the target; generating a first time signal corresponding to the transmission; receiving laser impulses reflected from the target; generating a second time signal corresponding to the reception; delaying said first time signal to provide at least a third time signal; calculating the time-of-flight by comparing said second time signal and said third time signal; calculating the distance of the target based on the calculated time of flight; and lighting one of a plurality of indicia on a reticle of a scope to indicate the appropriate reticle scale to aim at the target.

### BRIEF DESCRIPTION OF THE DRAWINGS

A preferred embodiment of the present invention will now be described, by way of example only, with reference to the accompanying drawings, in which:

FIG. 1 is a schematic diagram showing the lens arrangement of a laser range finder scope according to a preferred embodiment of the present invention;

FIG. 2 is a schematic diagram showing the operational arrangement of the laser range finder scope of FIG. 1;

FIG. 3 is a schematic diagram showing a circuit arrangement of the laser range finder scope of FIG. 1;

FIG. 4A is a conventional reticle;

FIG. 4B is a recticle of the laser range finder scope of FIG. 1;

FIG. 5 shows a first delay arrangement of the laser range finder scope of FIG. 1; and

FIG. 6 shows a second delay arrangement of the laser range finder scope of FIG. 1.

### DETAILED DESCRIPTION OF THE PREFERRED EMBODIMENT

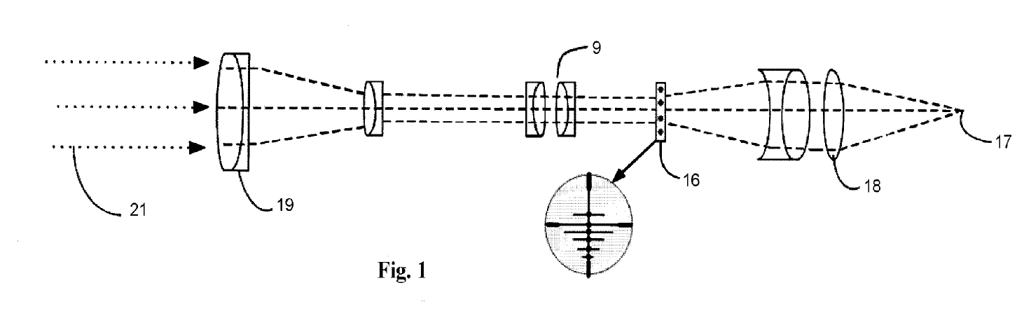

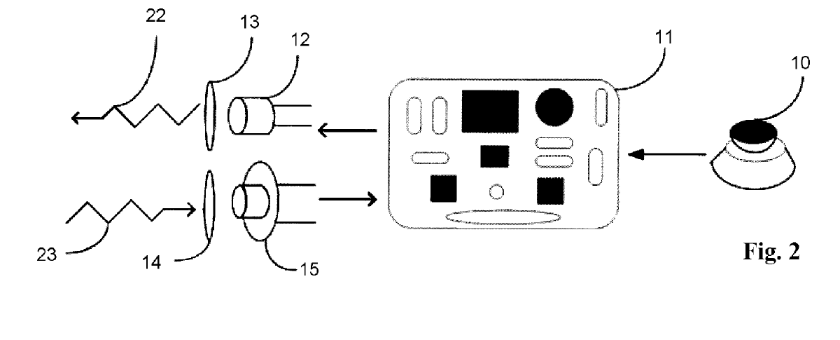

As shown in FIGS. 1 and 2, a laser range finder scope according to a preferred embodiment of the present invention includes a lens assembly 9 with a number of optical lens, including an object lens 19 and an ocular lens 18, arranged for manipulating light 21 from a target to magnify the image of the target for viewing by a shooter at 17. A reticle 16 is positioned in the lens assembly 9 for providing accurate aiming resolution and guidance, in a manner to be discussed below.

When in use, a shooter presses a button 10 to activate a circuit 11 to generate a signal pulse to drive a laser diode 12 to emit an infra-red laser beam 22 towards the target. The laser beam 22 is outputted from the laser range finder scope through an optical lens 13 to reduce output noise. Laser 23 falling onto and reflected by the target is detected by an Avalanche photodiode (APD) 15 via an optical lens 14 for reducing the noise in the received signals caused by the environment. The APD 15 converts the optical signals into electrical signals to enable the circuit 11 to calculate the distance of the target. In particular, the circuit 11 calculates the time-of-flight between transmission of the laser beam 22 and reception of the laser beam 23 reflected by the target.

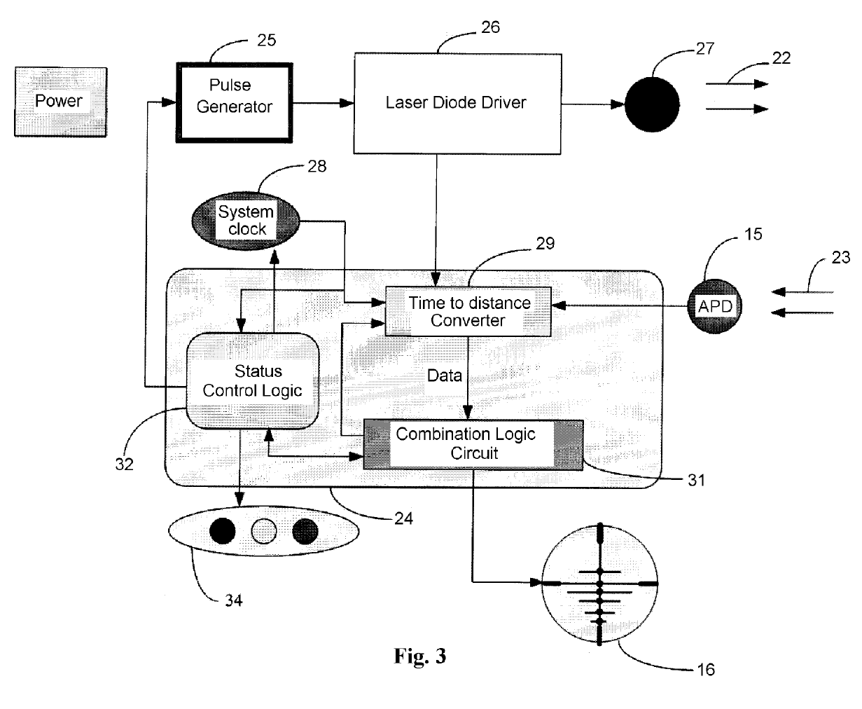

Turning now to FIG. 3, upon pressing of the button 10, the circuit 11 activates a pulse generator 25 to trigger a laser diode driver 26, which provides power to activate a laser diode 27 to emit a narrow laser beam 22. The APD 15 detects the laser light 23 reflected from the target, converts the signals into electrical signals, and feeds the converted signals to a time-to-distance converter 29. The time-to-distance converter 29 calculates the time-of-flight of the emitted laser 22 and the reflected light 23, with reference to time signals of a system clock 28. Thus, choosing a system clock 28 with a higher frequency can increase the resolution of distance measurement. Data outputted by the time-to-distance converter 29 are fed to a combination logic circuit 31 for mapping the data output with a certain output pattern on the reticle 16.

The combination logic circuit 31 also controls the operation of the converter 29 and a status control logic 32. When the APD 15 does not receive any reflected laser beam and the converter 29 reaches full state (overflows), the combination logic circuit 31 will reset the converter 29 and provide signals to the status control logic 32 indicative of an overflow at the converter 29.

If the status control logic 32 receives signals indicating that the converter 29 overflows, the status control logic 32 will determine whether the converter 29 is to recalculate the time of flight or not on the basis of the control from the system clock 28 and the pulse generator 25. The status control logic 32 also provides an overall control, with an interface 34 allowing the shooter to implement input switch control and displaying the current status of the system.

The status control logic 32, the time-to-distance converter 29, and the combination logic circuit 31 are all integrated into a complex programmable logic device (CPLD) or a field-programmable gate array (FPGA) type integrated circuit (IC) 24, which affords a small size circuit, short gate-to-gate propagation time, low cost, and the ability to implement a high speed circuit.

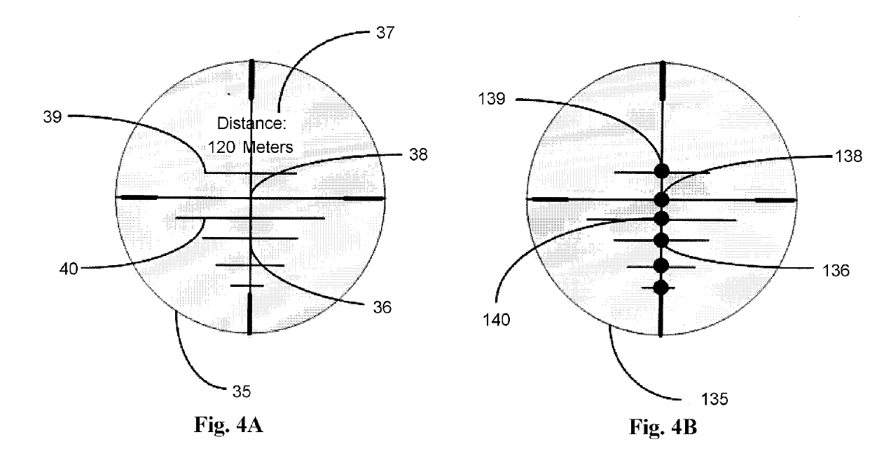

FIG. 4A shows a conventional reticle 35, which displays in word form 37 the distance of the target measured by a conventional laser range finder scope, e.g. “Distance: 120 Meters”. For example, in this conventional reticle 35, the centre reticle 38 is set for a 100-meter shooting distance, the next upper reticle scale 39 is 20 meters less than the centre reticle 38, i.e. 80 meters, whereas the next lower reticle scale 40 is 20 meters more than that of the centre reticle 38, i.e. 120 meters. Thus, if the measured distance is 120 meters, the shooter should aim the reticle scale 40 at the target, whereas if the measured distance is 80 meters, the shooter should aim the reticle scale 39 at the target. A disadvantage associated with this conventional reticle 35 (and thus a laser range finder scope with this conventional reticle 35) is that the shooter has to carry out calculation before arriving at the proper reticle scale for aiming. It also means that the shooter has to know the pre-set shooting distance of the centre reticle 38 and the difference of distance between successive reticle scales.

According to the present invention, a new reticle 135 is provided, and as shown in FIG. 4B. In this reticle 135, once the laser range finder scope according to this invention determines the distance between the scope and the target, it does not display the distance on the reticle 135 in word form, but will light up one of a number of lightable dots to indicate the reticle scale which the shooter should use for aiming at the target. In this way, the shooter does not have to carry out any calculation, nor to know the distance difference between successive reticle scales.

Assuming that in the new reticle 135, the centre reticle 138 is set for a 100-meter shooting distance, the next upper reticle scale 139 is 20 meters less than the centre reticle 138, i.e. 80 meters, whereas the next lower reticle scale 140 is 20 meters more than that of the centre reticle 38, i.e. 120 meters. If the measured distance of the target is 100 meters, only the red dot on the reticle scale 138 will light up; if the measured distance is 120 meters, only the red dot on the reticle scale 140 will light up; and if the measured distance is 80 meters, only the red dot on the reticle scale 139 will light up, and so on. The shooter then simply aims the lighted red dot on the reticle 135 at the magnified image of the target for shooting.

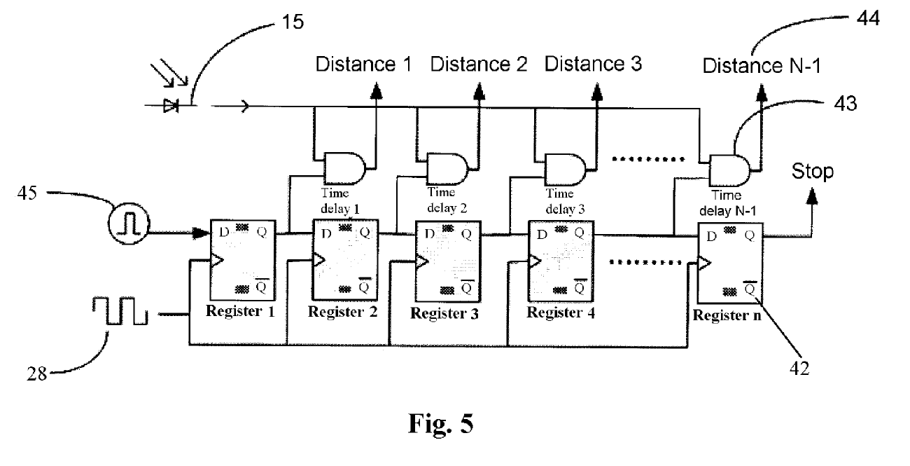

As a first implementation of a time-to-distance converter 29, and as shown in FIG. 5, a time-to-distance converter 29 includes a shift register 42 with a number of registers (Register 1, Register 2, . . . Register n) connected in series, which provides a fixed time delay function, and the time delay propagates from one register to another. When a shooter presses the button 10, simultaneously with the transmission of the laser beam 22, a start measure signal 45 is generated and received at the input of Register 1, and the shift register 42 begins generating the time delay from register to register, with the time delay based on the frequency of the system clock 28.

Each register (Register 1, Register 2, . . . Register n) is connected with a respective AND gate 43 for inputting different time delay for output by the respective AND gate 43. The APD 15, upon reception of the reflected laser signal, also outputs signals to the input of the AND gates 43. Only one AND gate 43 will have an operational logic high of both the APD 15 input and the register input, and the time delay of that AND gate 43 is taken as the time that has elapsed between transmission and reception of the laser beam, and to be used for arriving at the distance between the scope and the target. Such an arrangement can minimize the number of components if the measured distance levels is relatively small, say up to ten distance levels.

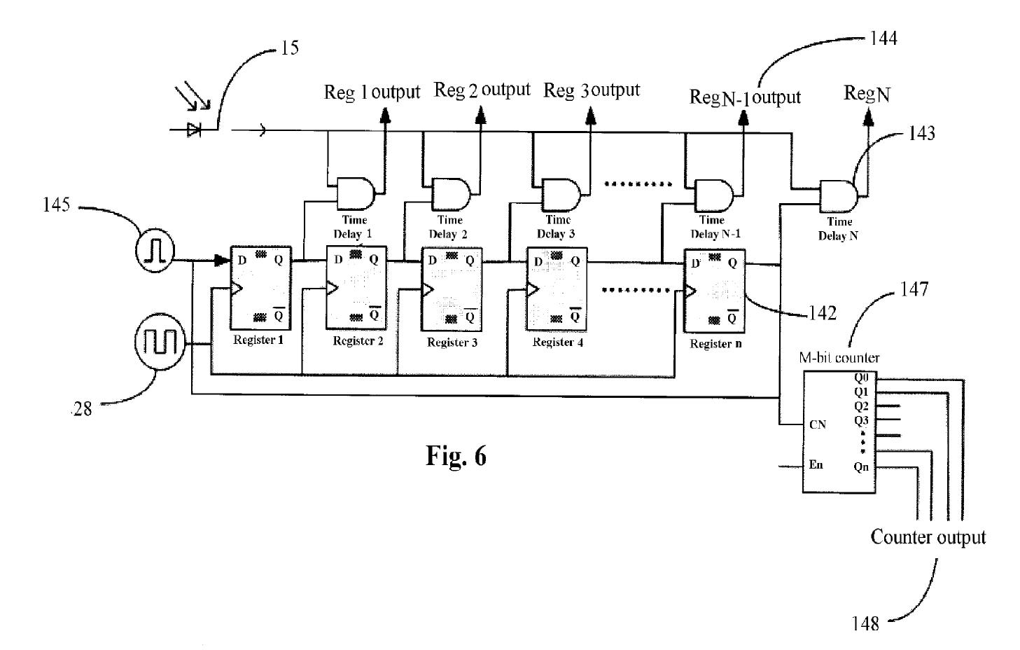

A more sophisticated arrangement of a time-to-distance converter 29 is shown in FIG. 6, in which a counter 147 is provided for counting the number of delay cycles which a shift register 142 has run. When a shooter presses the button 10, simultaneously with the transmission of the laser beam 22, a start measure signal 145 is generated and received at the input of Register 1, and the shift register 142 begins generating the time delay from register to register, with the time delay based on the frequency of the system clock 28.

Each register (Register 1, Register 2, . . . Register n) is connected with a respective AND gate 143 for inputting different time delay for output by the respective AND gate. The APD 15, upon reception of the reflected laser signal, also outputs signals to the input of the AND gates 143. Only one AND gate 143 will have an operational logic high of both the APD 15 input and the register input. The counter 147 counts the number of cycles of running of the shift register 142. The counter output 148 is multiplied by the current delay time value from the current shift register 142 to calculate the time delay, corresponding to the time-of-flight of the laser pulse. In such an arrangement, it only requires a shift register with eight registers and a 4-bit counter to provide up to 8*6−1 (i.e. 127) time delay levels.

It should be understood that the above only illustrates examples whereby the present invention may be carried out, and that various modifications and/or alterations may be made thereto without departing from the spirit of the invention.

It should also be understood that certain features of the invention, which are, for clarity, described in the context of separate embodiments, may be provided in combination in a single embodiment. Conversely, various features of the invention which are, for brevity, described in the context of a single embodiment, may also be provided separately or in any appropriate sub-combinations.

1. A laser range finder scope for measuring the distance between a target and the scope based on the time-of-flight of laser impulses; including:
means for transmitting laser impulses toward the target and generating a first time signal corresponding to the transmission;
means for receiving laser impulses reflected from the target and generating a second time signal corresponding to the reception;
means for delaying said first time signal to provide at least a third time signal; means for calculating the time-of-flight by comparing said second time signal and said third time signal; and
a scope with a reticle with a plurality of indicia selectively lightable to each indicate the appropriate reticle scale to aim at the target.

2. A laser range finder scope according to claim 1 wherein said indicia are dots each on a respective reticle scale.

3. A laser range finder scope according to claim 1 wherein said delaying means includes a shift register with a plurality of registers.

4. A laser range finder scope according to claim 3 wherein each said register of said shift register is connected with a respective AND gate.

5. A laser range finder scope according to claim 3 further including a counter for calculating the number of cycles of running of said shift register.

6. A laser range finder scope according to claim 4 further including a counter for calculating the number of cycles of running of said shift register.

7. A method for indicating the distance of a target based on the time-of-flight of laser impulses; including steps of:
transmitting laser impulses toward the target;
generating a first time signal corresponding to the transmission;
receiving laser impulses reflected from the target;
generating a second time signal corresponding to the reception;
delaying said first time signal to provide at least a third time signal;
calculating the time-of-flight by comparing said second time signal and said third time signal; and
calculating the distance of the target based on the calculated time of flight;
lighting one of a plurality of indicia on a reticle of a scope to indicate the appropriate reticle scale to aim at the target.

8. A method according to claim 7 wherein said indicia are dots each on a respective reticle scale.

9. A method according to claim 7 wherein said step of delaying said first time signals is carried out by a shift register with a plurality of registers.

10. A method according to claim 9 wherein each said register of said shift register is connected with a respective AND gate.

11. A method according to claim 9 or 10 further providing a counter for calculating the number of cycles of running of said shift register.

12. A method according to claim 10 further providing a counter for calculating the number of cycles of running of said shift register.
